(19) United States
(12) Patent Application Publication
(10) Pub. No.: US 2005/0133006 A1
(43) Pub. Date: Jun. 23, 2005

(54) Method and device for operating a vehicle having an internal combustion engine

(76) Inventors: Thomas Frenz, Noerdlingen (DE); Andreas Kufferath, Besrgheim (DE)

Correspondence Address: KENYON & KENYON, ONE BROADWAY, NEW YORK, NY, 10004, US

(21) Appl. No.: 11/016,614

(22) Filed: Dec. 17, 2004

(30) Foreign Application Priority Data
Dec. 20, 2003 (DE) 103 60 340.9

(51) Int. Cl. F02D 1/00

(52) U.S. Cl. 123/399; 123/325

(57) ABSTRACT

A method and a device are provided for operating a vehicle having a combustion engine, which result in reduced fuel consumption in overrun operation. In the process, the air supply to the combustion engine is adjusted via an actuator. In overrun operation of the combustion engine, an opening degree of the actuator is set as a function of a driving situation.

### FIELD OF THE INVENTION

The present invention relates to a method and a device for operating a vehicle having an internal combustion engine.

### BACKGROUND INFORMATION

Methods and devices for operating a vehicle having an internal combustion engine in which the air supply to the combustion engine is adjusted via an actuator are conventional, a throttle valve generally being used as actuator.

In modern spark-ignition engines, in overrun operation, the fuel injection is turned off whenever possible in an effort to lower the fuel consumption. The throttle valve is closed. This brings about a high brake torque of the combustion engine, the so-called engine brake. Due to the high engine-brake torque, the vehicle speed is considerably reduced in overrun operation. In certain driving situations this may not be intended, and the driver must leave overrun operation again after a short time. If the throttle valve were open in this case, a considerably lower engine-brake torque would come about and the vehicle could travel in overrun operation for a longer period of time.

### SUMMARY

An example method and device of the present invention for operating a vehicle, which includes an internal combustion may have the advantage that, in an overrun operation of the combustion engine, an opening degree of the actuator is set as a function of a driving situation. This makes it possible in overrun operation to distinguish between driving situations during which either a high or a low engine-brake output is desired, so that in overrun operation the brake output of the combustion engine is set according to the driving situation via a corresponding adjustment of the actuator, in such a way that the vehicle is traveling in the most optimal manner from the standpoint of fuel economy. This allows the fuel consumption to be reduced.

It may be particularly advantageous if the driving situation is ascertained by evaluating a gradient of a variable derived from an actuation of the accelerator. This allows the driving situation to be ascertained in a particularly reliable manner on the basis of the driver input.

By determining the driving situation in this manner, the opening degree of the actuator is able to be adjusted in an especially simple manner in that the opening degree of the actuator is reduced in the direction of the closed position of the actuator when the gradient falls below a specified threshold value, and in that the opening degree of the actuator is increased in the direction of a full opening of the actuator when the gradient is above the predefined threshold value.

As an alternative, it is possible to ascertain the actuator opening degree to be set in overrun operation, or to ascertain a variable characterizing this opening degree, as a function of the gradient of the variable derived from the accelerator actuation, using a characteristic curve or a characteristics map for this purpose. This allows the actuator opening degree or the variable characterizing this opening degree to be adjusted in a more differentiated manner as a function of the driving situation.

An additional advantage results if the driving situation is ascertained by analyzing an actuation of the brake pedal. This, too, allows the driving situation to be determined in a particularly reliable and uncomplicated manner.

This may be realized in a very simple manner by reducing the actuator opening degree in the direction of the closed position of the actuator when the brake pedal is depressed, and by increasing the actuator opening degree in the direction of a full opening of the actuator when the brake pedal is released.

Another advantageous possibility for ascertaining the driving situation results if the driving situation is determined by evaluating information concerning an inclination of the vehicle relative to the horizontal line. In this manner, the driving situation may be ascertained independently of the driver input.

To accomplish this without further measures, the actuator opening degree is reduced in the direction of the closed position of the actuator in the event that the magnitude of the inclination exceeds a specified threshold value, and the actuator opening degree is increased in the direction of the fully open position of the actuator in the event that the magnitude of the inclination falls short of the specified threshold value.

The driving situation may be determined in an even more reliable manner if the driving situation is ascertained by evaluating a driving speed.

It is also advantageous if the actuator opening degree is reduced in the direction of the closed position of the actuator if a fault is detected in a safety-relevant component of the vehicle or the combustion engine. This prevents a faulty and safety-critical operation of the vehicle.

### BRIEF DESCRIPTION OF THE DRAWINGS

Exemplary embodiments of the present invention are represented in the figures and explained in greater detail in the following description.

FIG. 1 shows a block diagram of a combustion engine.

FIG. 2 shows a flow chart of an exemplary realization of the method and device according to the present invention.

FIG. 3 shows a flow chart of an exemplary time sequence of the example method according to the present invention.

FIG. 4 shows an alternative flow chart to the flow chart of FIG. 3.

### DESCRIPTION OF EXAMPLE EMBODIMENTS

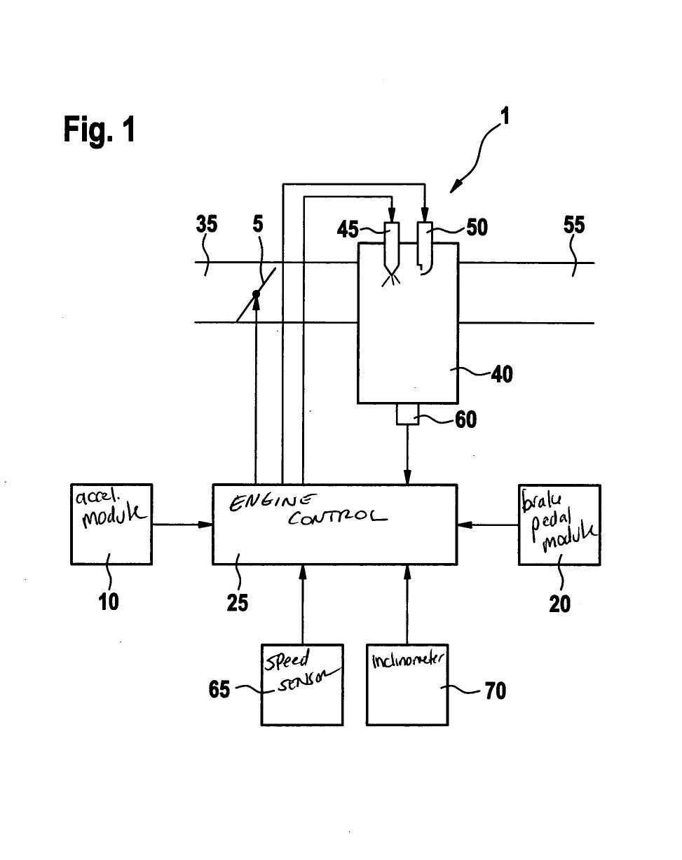

Reference numeral 1 in FIG. 1 denotes a combustion engine, which drives a vehicle and may be embodied as spark-ignition engine or diesel engine, for instance. In the following, it is assumed by way of example that internal combustion engine 1 takes the form of a spark-ignition engine. Combustion engine 1 includes one or more cylinder(s) 40 whose combustion chamber is supplied with combustion air via an air supply 35. Disposed in air supply 35 is an actuator 5, which is to be embodied as electronically controlled throttle valve in this example and whose opening degree is adjusted by an engine control 25. In this way, the cylinder charge is able to be set or controlled as a function of the opening degree of throttle valve 5. In the case of direct injection of fuel into individual cylinders 40, as indicated in FIG. 1, the fuel is injected directly into the combustion chamber of the corresponding cylinder via an individual fuel injector 45, the injection quantity and injection time also being specified by engine control 25. As an alternative, the injection of fuel could also be implemented into the section of air supply 35 between throttle valve 5 and the intake valves (not shown in FIG. 1 for reasons of clarity) of cylinders 40, this section being denoted as intake manifold. The air/fuel mixture formed in the combustion chamber of cylinders 40 is ignited via an individual spark plug 50 provided for each cylinder 40, engine control 25 also controlling spark plugs 50 with respect to their ignition firing point. The exhaust gas produced in the combustion of the air-fuel mixture is discharged via an exhaust-system branch 55. Disposed in the region of cylinders 40 is an engine speed sensor 60, which detects the rotational speed of combustion engine 1 in a conventional manner and relays the measured value to engine control 25. Furthermore, a speed sensor 65 is provided, which detects the driving speed of the vehicle in a conventional manner and forwards the measured value to engine control 25. In addition, according to FIG. 1, an inclinometer 70 is present, which detects the inclination of the vehicle relative to the horizontal line in a conventional manner and forwards the measured value to engine control 25. Moreover, an accelerator is provided whose activation degree or pedal angle is detected by an accelerator module 10, and forwarded to engine control 25 as well. In addition, a brake pedal is provided whose activation degree is detected by a brake pedal module 20 and is likewise forwarded to engine control 25.

According to the example embodiment of the present invention, driving situations in which a high engine brake torque or a low engine brake torque is desired must be distinguished in an overrun operation of the vehicle. As a function of the detected driving situation, throttle valve 5 will then be controlled in such a way that the desired engine brake torque is generated, thereby allowing the fuel consumption to be reduced. According to the present invention, it is thus the case that, in overrun operation of the vehicle or combustion engine 1, the opening degree of throttle valve 5 is adjusted as a function of the instantaneous driving situation.

There are various ways of ascertaining the instantaneous driving situation. One possibility is to determine the gradient of a variable derived from an activation of the accelerator. This variable may be the activation degree of the accelerator, or pedal angle wped_w, for example. Hereinafter, it is to be assumed by way of example that the variable derived from the activation of the accelerator is pedal angle wped_w. Therefore, if overrun operation of the vehicle or combustion engine 1 was reached by a rapid release of the accelerator, this indicates that a high engine brake torque is to be adjusted in overrun operation. On the other hand, if overrun operation of the vehicle or combustion engine 1 was reached by a slow release of the accelerator, this indicates that a low engine brake torque is to be adjusted in overrun operation. In the simplest case, it may therefore be provided that a threshold value Typed_w be specified for the gradient of pedal angle wped_w and stored in engine control 25. Threshold value Typed_w may be applied in a suitable manner on a test stand, for instance. Specified threshold value Typed_w is selected as a negative value since a negative time gradient of pedal angle wped_w will come about as well upon release of the accelerator. From pedal angle wped_w of the accelerator, relayed to engine control 25 via accelerator module 10, engine control 25 determines the time gradient of this pedal angle wped_w. If this gradient is below specified threshold value Typed_w when the accelerator is released, a fast release of the accelerator has occurred and a high engine brake torque is desired. In this case, engine control 25 will control throttle valve 5 in such a way that the opening degree of throttle valve 5 is reduced in the direction of the closed position of throttle valve 5. This may be achieved, for instance, by closing throttle valve 5 completely, thereby producing a maximum engine brake torque. If upon release of the accelerator the gradient exceeds specified threshold value Typed_w, a slow release of the accelerator is present and a low engine brake torque is desired. In this case engine control 25 will control throttle valve 5 in such a way that the opening degree of throttle valve 5 is increased in the direction of a full opening of throttle valve 5. This may be accomplished, for instance, by opening throttle valve 5 completely, thereby producing a minimum engine brake torque. When selecting specified threshold value Typed_w, it must therefore be taken into account that gradients of pedal angle wped_w above this threshold value Typed_w also correlate only to a driver wish for a minimum engine brake torque and that the gradients of pedal angle wped_w below this threshold value Typed_w also correlate only to a driver wish for a maximum engine brake torque.

According to an alternative specific embodiment, a more differentiated adjustment of the opening degree of throttle valve 5 as a function of the driving situation is possible in overrun operation. Here, the opening degree of throttle valve 5 to be adjusted, or a variable characterizing this opening degree, is determined as a function of the gradient of the variable derived from the activation of the accelerator—in this example pedal angle wped_w—using a characteristic curve or a characteristics map. The variable characterizing the opening degree of throttle valve 5 may be, for example, a setpoint value wped_wsetpoint for the pedal angle, which is proportional to an opening degree of throttle valve 5, by which setpoint value wped_wsetpoint of the pedal angle can be converted in order to realize a corresponding driver-desired torque. The advantage of the characteristic-curve approach is that for each gradient of pedal angle wped_w an associated opening degree of throttle valve 5, or—in this example—an associated setpoint value wped_wsetpoint of the pedal angle may be gathered from the characteristic curve, so that the opening degree of throttle valve 5 is able to be adjusted in a more differentiated manner as a function of the gradient of pedal angle wped_w. Of course, it may also be provided that either a fully closed throttle valve 5 or a fully open throttle valve 5 will come about as output variable of the characteristic curve, so that the same result is achieved as in the afore-described threshold-value approach. The use of a characteristics map will be required if not only the gradient of pedal angle wped_w, but one or a plurality of further input variables is to be considered as well when determining the instantaneous driving situation in overrun operation. This may be the driving speed, for instance. The characteristic curve or the characteristics map may be suitably applied on a test stand, for example, in order to assign an appropriate setpoint value wped_wsetpoint for the pedal angle to the particular time gradient of pedal angle wped_w, and thus a suitable opening degree of throttle valve 5 for setting the desired engine brake torque in overrun operation.

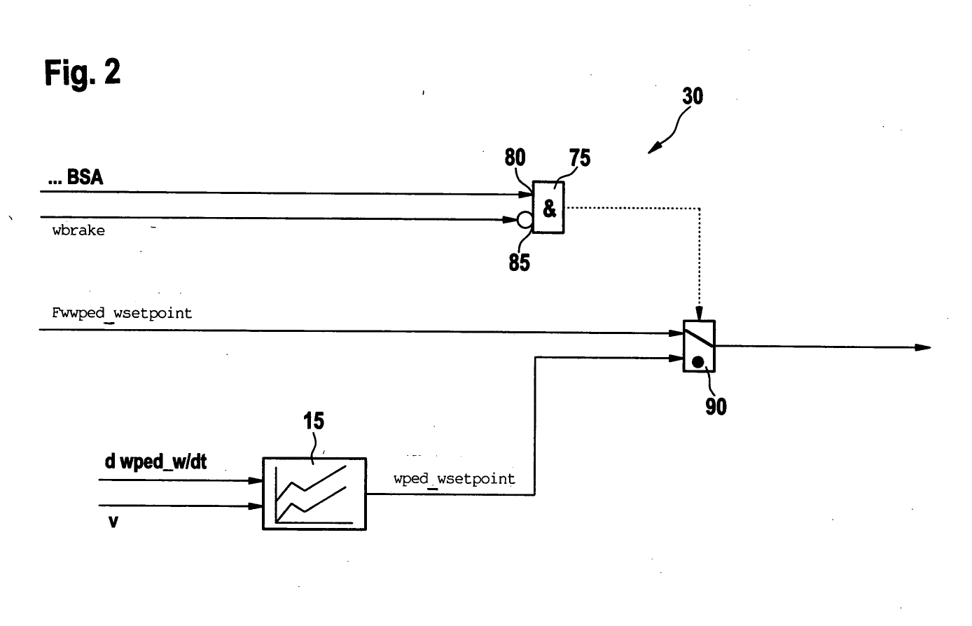

FIG. 2 shows a flow chart illustrating the adjustment of the opening degree of throttle valve 5 as a function of the driving situation in overrun operation. In this case, setpoint value wped_wsetpoint for the pedal angle is specified as characteristic variable for the opening degree of throttle valve 5, controlled via characteristics map as a function of the gradient of pedal angle wped_w and the driving speed. Reference numeral 30 in FIG. 2 denotes a control unit, which may be implemented in engine control 25 in the form of hardware and/or software, for instance. On the one hand, a controlled switch 90 of control unit 30 is supplied with a setpoint value FWped_wsetpoint for the pedal angle in accordance with a driver wish or a request by a vehicle function such as an anti-lock braking system, a traction control, an electronic stability program or the like, and with output variable wped_wsetpoint of a characteristics map 15, which also represents a setpoint value for the pedal angle, on the other hand. Controlled switch 90 is triggered by an output signal of an AND gate 75. If this output signal of AND gate 75 is set, controlled switch 90 is induced to provide output signal wped_wsetpoint of characteristics map 15 at its output. If this output signal of AND gate 75 is not set, controlled switch 90 is induced to provide signal Fwped_wsetpoint at its output. A first input 80 of AND gate 75 is supplied with an overrun turn-off signal BSA, which indicates whether combustion engine 1 or the vehicle is in overrun operation, i.e., it indicates that overrun operation is active. This may easily be determined in engine control 25 by checking whether accelerator 10 has been released and is therefore no longer activated. In this case overrun operation is present and engine control 25 sets overrun turn-off signal BSA. Otherwise, i.e., when the accelerator is still activated, no overrun operation is taking place and engine control 25 will not set or reset overrun turn-off signal BSA. A brake pedal signal wbrake, which is set by engine control 25 when the brake pedal is activated and which will not be set or reset by engine control 25 when the brake pedal is not activated, is supplied to a second inverted input 85 of AND gate 75. To this end, engine control 25, in a corresponding manner, evaluates the activation degree of the brake pedal provided by brake pedal module 20. Thus, the output signal of AND gate 75 will be set only when overrun operation is present and the brake pedal is not activated. Otherwise the output signal of AND gate 75 will not be set. Input variables of characteristics map 15 are vehicle speed v, which is ascertained by speed sensor 65, and time gradient dwped_w/dt of pedal angle wped_w, which is supplied to engine control 25 by accelerator module 10, time gradient dwped_w/dt being formed by engine control 25. Characteristics map 15 assigns setpoint value wped_wsetpoint for the pedal angle to time gradient dwped_w/dt of the pedal angle and speed v, which leads to the corresponding desired opening degree of throttle valve 5. It may be provided here that, with increasing gradient dwped_w/dt of pedal angle wped_w and constant vehicle speed v, setpoint value wped_wsetpoint for the pedal angle and thus the opening degree of throttle valve 5 be increased so as to reduce the engine brake torque, and, with increasing driving speed v and constant time gradient dwped_w/dt of pedal angle wped_w, setpoint value wped_wsetpoint for the pedal angle and thus the opening degree of throttle valve 5 be reduced so as to increase the engine brake torque, in this manner increasing the road safety by lowering the driving speed during overrun operation.

If the instantaneous driving situation is ascertained as described as a function of time gradient dwped_w/dt of pedal angle wped_w, time gradient dwped_w/dt of pedal angle wped_w is the time gradient present when the accelerator is released to attain overrun operation.

In addition or as an alternative to determining the instantaneous driving situation as a function of time gradient dwped_w/dt of pedal angle wped_w, the instantaneous driving situation may also be determined by evaluating an activation of the brake pedal. It may be provided that the opening degree of throttle valve 5 be reduced in the direction of the closed position of throttle valve 5 when the brake pedal is depressed, it being possible in this case for throttle valve 5 to be closed completely, for instance. It may likewise be provided that the opening degree of throttle valve 5 be increased in the direction of a complete opening of throttle valve 5 when the brake pedal is released, it being possible in this case for throttle valve 5 to be opened completely, for instance.

Engine control 25 ascertains the activation or non-activation of the brake pedal from the activation degree of the brake pedal supplied by brake pedal module 20. An instantaneous driving situation in overrun operation is therefore able to be determined on the basis of the activation degree of the brake pedal with a view toward a desired high engine brake torque if an activated brake pedal is detected. Conversely, an instantaneous driving situation in overrun operation is able to be determined on the basis of the activation degree of the brake pedal with a view toward a desired low engine brake torque when a released brake pedal is detected.

Also in the event that the instantaneous driving situation is determined as a function of the activation degree of the brake pedal, it may be provided that various activation degrees of the brake pedal are assigned to different opening degrees of throttle valve 5, such assignment being implementable via a characteristic curve. This in turn results in a more differentiated adjustment of the opening degree of throttle valve 5 as a function of the activation degree of the brake pedal. If the instantaneous driving situation is determined by other variables as well, for example on the basis of driving speed v and/or time gradient dwped_w/dt of pedal angle wped_w, all of these variables characterizing the instantaneous driving situation may be entered as input variables into a characteristics map whose output variable is the opening degree of throttle valve 5 or a variable characterizing the opening degree of throttle valve 5, for instance mentioned setpoint value wped_wsetpoint for pedal angle wped_w. The characteristic curve or characteristics map may in turn be suitably applied on a test stand, for example. On the basis of characteristics map 15 in FIG. 2 and according to the flow chart of FIG. 2, the activation degree of the brake pedal may be entered as an additional input variable of characteristics map 15, it being the case that setpoint value wped_wsetpoint of pedal angle wped_w, and thus the opening degree of throttle valve, is reduced with increasing activation of the brake pedal, given constant driving speed v as well as constant time gradient dwped_w/dt of pedal angle wped_w. In this case, controlled switch 90 may also be controlled solely by overrun turn-off signal BSA, in such a way that the output of characteristics map 15 will be present at the output of controlled switch 90 when overrun turn-off signal BSA is set, and setpoint value FWwped_wsetpoint will be present otherwise.

In addition or as an alternative to determining the instantaneous driving situation as a function of time gradient dwped_w/dt of pedal angle wped_w and/or the activation degree of the brake pedal and/or driving speed v, the instantaneous driving situation may also be determined by evaluating information regarding tilting of the vehicle relative to the horizontal line. For this purpose, engine control 25 evaluates the signal from inclinometer 70. It is possible that a tilting threshold value N for the tilting of the vehicle relative to the horizontal line is specified in engine control 25. For example, it may be provided that the opening degree of throttle valve 5 be reduced in the direction of the closed position of throttle valve 5 when the magnitude of the tilting of the vehicle relative to the horizontal line exceeds specified tilting threshold value N; in such a case it is possible that throttle valve 5 will be completely closed, for instance. It may likewise be provided that the opening degree of throttle valve 5 be increased in the direction of full opening of throttle valve 5 when specified inclination threshold value N is not attained by the magnitude of the inclination of the vehicle relative to the horizontal line; it is possible in such a case that throttle valve be opened completely, for instance. As a result, in overrun operation, an instantaneous driving situation may be detected on the basis of the inclination of the vehicle relative to the horizontal line in view of a desired high engine brake torque when a roadway incline of high magnitude is detected, which is above tilting threshold value N and corresponds to the tilting of the vehicle relative to the horizontal line. In this case a high engine brake torque is desired for reasons of traffic safety. Conversely, it is possible to detect an instantaneous driving situation in overrun operation on the basis of the inclination of the vehicle relative to the horizontal line in view of a desired low engine brake torque when a roadway incline of low magnitude is present, which is below inclination threshold value N and corresponds to the inclination of the vehicle relative to the horizontal line. In this case, a high engine brake torque is not required for reasons of traffic safety, and a lower engine brake torque may be set. Inclination threshold value N may be suitably selected on a test stand, for example, or in driving tests so as to satisfy the required demands with respect to traffic safety.

Also in the event that the instantaneous driving situation is determined as a function of the inclination of the vehicle relative to the horizontal line, provision may be made to assign various inclinations of the vehicle relative to the horizontal line to a different opening degree of throttle valve 5 in each case, the assignment being implementable via a characteristic curve. In this manner, a more differentiated adjustment of the opening degree of throttle valve 5 as a function of the vehicle inclination relative to the horizontal line may be achieved again. If the instantaneous driving situation is additionally determined by other variables as well, such as driving speed v and/or time gradient dwped_w/dt of pedal angle wped_w and/or the activation of the brake pedal, all of these variables characterizing the instantaneous driving situation may be entered as input variables into a characteristics map whose output variable is the opening degree of throttle valve 5 or a variable characterizing the opening degree of throttle valve 5, such as mentioned setpoint value wped_wsetpoint for pedal angle wped_w. The characteristic curve or characteristics map may in turn be applied in a suitable manner on a test stand, for instance. On the basis of characteristics map 15 in FIG. 2 and according to the flow chart illustrated in FIG. 2, the inclination of the vehicle with respect to the horizontal line may be entered as an additional input variable of characteristics map 15; as the tilting of the vehicle relative to the horizontal line increases, driving speed v and time gradient dwped_w/dt of pedal angle wped_w, and the activation of the brake pedal remaining constant, setpoint value wped_wsetpoint of pedal angle wped_w, and thus the opening degree of throttle valve 5, is reduced. In this case, controlled switch 90 may also be controlled solely by overrun turn-off signal BSA, in such a way that the output of characteristics map 15 will be present at the output of controlled switch 90 if overrun turn-off signal BSA is set, and setpoint value FWwped_wsetpoint will be present in the other case.

Furthermore, it may optionally be provided that upon detection of a fault in a safety-relevant component or in a characteristic or performance quantity of the vehicle or combustion engine 1, the opening degree of throttle valve 5 be reduced in the direction of the closed position of throttle valve 5 for reasons of safety, so as to increase the engine brake torque and to brake the vehicle as quickly as possible. The greatest braking action is achieved when throttle valve 5 is closed completely. The anti-lock braking system or the power brakes are cited as examples of a safety-relevant component of the vehicle. The engine temperature or the oil level of the engine are mentioned as example for a safety-relevant performance quantity of combustion engine 1. If safety-relevant components fail or if they are detected to be faulty in some other way by engine control 25 or if safety-relevant characteristics or performance quantities are outside their permissible range, throttle valve 5 will be moved in the direction of its closed position and will preferably be closed completely if overrun operation is present, independently of the instantaneous driving situation, in an attempt to realize the greatest possible engine brake torque.

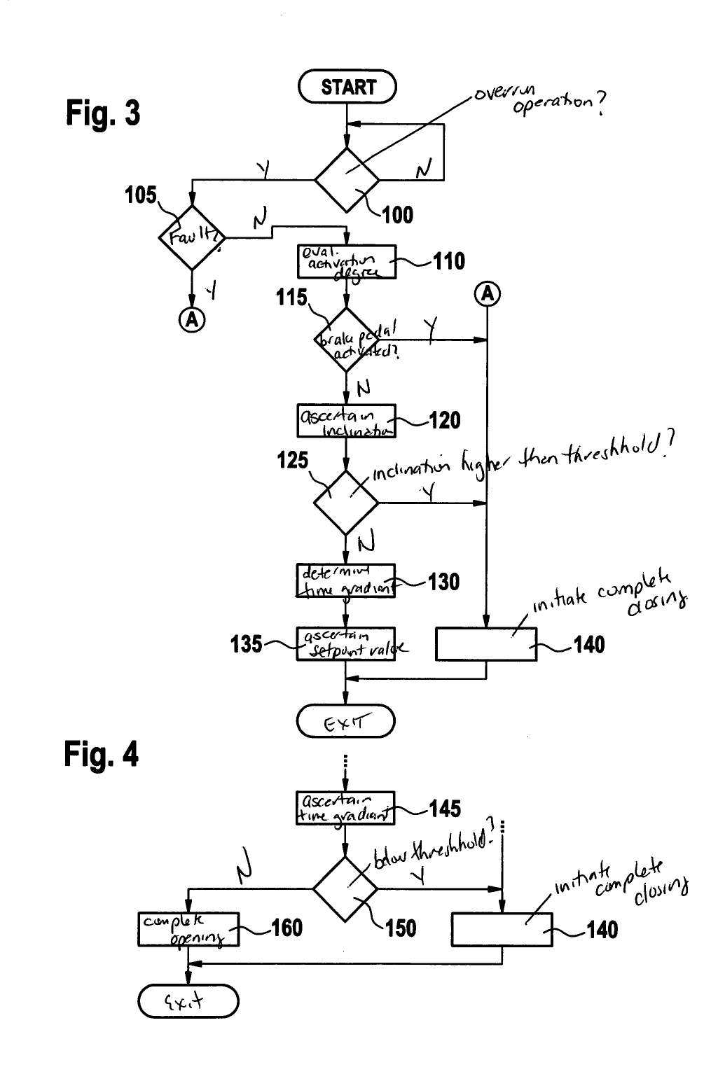

FIG. 3 shows a flow diagram of an exemplary sequence of the method according to the present invention. Following the program start, in a program point 100, engine control 25 ascertains whether overrun operation is present. If this is the case, the program branches to a program point 105, otherwise the program branches back to program point 100. The check for overrun operation may be carried out in the manner described, in that engine control 25 evaluates the activation degree of the accelerator. If the accelerator is released, engine control 25 detects overrun operation and sets overrun turn-off signal BSA, otherwise engine control 25 detects acceleration operation and will reset overrun turn-off signal BSA.

In program point 105, engine control 25 checks whether a fault has occurred in a safety-relevant component or performance quantity of the vehicle or combustion engine 1. If this is the case, the method branches to program point 140, otherwise the method branches to program point 110.

In program point 110, engine control 25 evaluates the activation degree of the brake pedal in the manner described. Subsequently, the program branches to a program point 115.

In program point 115, engine control 25 checks whether the brake pedal has been activated. If this is the case, the method branches to program point 140, otherwise the method branches to program point 120.

In program point 120, engine control 25 evaluates the information from inclinometer 70 and ascertains the inclination of the vehicle relative to the horizontal line and thus the incline of the roadway. Subsequently, the program branches to a program point 125.

In program point 125, engine control 25 checks whether the magnitude of the inclination of the vehicle relative to the horizontal line is higher than specified inclination threshold value N. If this is the case, the method branches to program point 140; in all other cases, the method branches to program point 130.

In program point 130, in the manner described, engine control 25 determines time gradient dwped_w/dt of pedal angle wped_w that was present when the accelerator was released in order to achieve overrun operation. To this end, the activation degrees of the accelerator are sampled, in a time-discrete manner, from the signal provided by accelerator module 10, and stored, so that the activation degrees of the accelerator are available in engine control 25 when the accelerator is released in order to set overrun operation and may be used to calculate time gradient dwped_w/dt of pedal angle wped_w. In addition, engine control 25 determines instantaneous driving speed v. Branching to a program point 135 will then take place.

In program point 135, according to characteristics map 15 from the flow chart shown in FIG. 2 (which will not be discussed further here), setpoint value wped_wseptpoint for the pedal angle, and thus the opening degree of throttle valve 5 to be set, will be ascertained by engine control 25 as a function of driving speed v and time gradient dwped_w/dt of pedal angle wped_w, and implemented by engine control 25. The program is subsequently exited. At program point 140, engine control 25 initiates the complete closing of throttle valve 5. Subsequently the program is exited.

According to the flow chart of FIG. 3, in overrun operation, it is therefore a mixed form of adjustment of the engine-brake torque, based on a characteristic curve and threshold value, that is introduced by way of example. The instantaneous driving situation with respect to the activation degree of the brake pedal and with respect to the tilting of the vehicle relative to the horizontal line is ascertained by means of a threshold-value decision; and with respect to gradient dwped_w/dt of pedal angle wped_w of the accelerator and vehicle speed v, the instantaneous driving situation is ascertained with the aid of a characteristics map.

Furthermore, to ascertain the instantaneous driving situation, the evaluation of the brake-pedal activation has priority over the evaluation of inclinometer 70, and the evaluation of inclinometer 70 has priority over the evaluation of gradient dwped_w/dt of pedal angle wped_w of the accelerator and driving speed v.

FIG. 4 represents a modification of the flow chart according to FIG. 3. Here, program points 130 and 135 are replaced by the program points shown in the flow chart according to FIG. 4. In all other respects, the flow chart according to FIG. 3 is retained unchanged. That is to say, according to the specific embodiment of FIG. 4, branching from program point 125 to a program point 145 will take place in the case of a no-decision.

In program point 145, in the manner described and as in program point 130 according to FIG. 3, engine control 25 ascertains time gradient dwped_w/dt of pedal angle wped_w that was present when the accelerator was released to achieve overrun operation. Subsequently, the program branches to a program point 150.

In program point 150, engine control 25 checks whether time gradient dwped_w/dt is below specified threshold value Typed_w. If this is the case, the method branches to program point 140; otherwise the method branches to a program point 160.

In program point 140, engine control 25 initiates a complete closing of throttle valve 5. Program point 140 has been adopted from the flow chart of FIG. 3. The program is subsequently exited.

In program point 160, engine control 25 initiates the complete opening of throttle valve 5. Subsequently the program is exited.

Both flow charts according to FIG. 3 and FIG. 4 show an exemplary sequence of the method according to the present invention. In general, it is possible to ascertain the instantaneous driving situation with respect to each mentioned criterium: time gradient dwped_w/dt of pedal angle wped_w, the actuation degree of the brake pedal, driving speed v, the inclination of the vehicle relative to the horizontal line, on the basis of a control using a characteristic curve or characteristics map or a control via a threshold value, and using any sequence, in a hierarchical or non-hierarchical manner, for instance with the aid of a single characteristics map for all mentioned criteria. Additional criteria such as the engine speed, which is ascertained by engine speed sensor 60, may be utilized to determine the instantaneous driving situation. The more criteria are utilized to determine the instantaneous driving situation, the more detailed and more precisely the instantaneous driving situation is able to be determined. In the manner described, the opening degree of throttle valve 5 to be set in overrun operation or a variable characterizing the opening degree of throttle valve 5 to be set, will then be determined from the ascertained instantaneous driving situation.

The method according to the present invention may be suspended if higher-priority goals, related to exhaust-gas demands or component protection demands, for instance, should require this.

1. A method for operating a vehicle having a combustion engine where the air supply to the combustion engine is adjusted via an actuator, the method comprising:
in overrun operation of the combustion engine, adjusting an opening degree of the actuator as a function of a driving situation.

2. The method as recited in claim 1, further comprising:
evaluating a gradient of a variable derived from an actuation of an accelerator to ascertain the driving situation.

3. The method as recited in claim 2, further comprising:
if the gradient is below a specified threshold value, reducing the opening degree of the actuator in the direction of a closed position of the actuator; and
if the gradient is above the specified threshold value, increasing the opening degree of the actuator in a direction of a complete opening of the actuator.

4. The method as recited in claim 2, further comprising:
ascertaining the opening degree of the actuator to be set in overrun operation or a variable characterizing the opening degree as a function of the gradient of the variable derived from the actuation of the accelerator using a characteristic curve or a characteristics map.

5. The method as recited in claim 1, further comprising:
determining the driving situation by analyzing an activation of a brake pedal.

6. The method as recited in claim 5, further comprising:
when the brake pedal is depressed, reducing the opening degree of the actuator in the direction of closed position of the actuator; and
when the brake pedal is released, increasing the opening degree of the actuator in a direction of complete opening of the actuator.

7. The method as recited in claim 1, further comprising:
ascertaining the driving situation by analyzing information regarding an inclination of the vehicle relative to a horizontal line.

8. The method as recited in claim 7, further comprising:
when a magnitude of the inclination exceeds a specified threshold value, reducing an opening degree of the actuator in a direction of a closed position of the actuator; and
when the magnitude of the inclination does not achieve the specified threshold value, increasing the opening degree of the actuator in a direction of a complete opening of the actuator.

9. The method as recited in claim 1, further comprising:
ascertaining the driving situation is ascertained by analyzing a driving speed.

10. The method as recited in claim 1, further comprising:
when a fault is detected in a safety-relevant component of the vehicle or the combustion engine, reducing an opening degree of the actuator in a direction of a closed position of the actuator.

11. A device for operating a vehicle having a combustion engine and an actuator for adjusting an air supply to the combustion engine, comprising:
a control device configured to adjust an opening degree of the actuator as a function of a driving situation, in overrun operation.
